(19) United States
(12) Patent Application Publication
(10) Pub. No.: US 2012/0207261 A1
(43) Pub. Date: Aug. 16, 2012

(54) Nuclear Power Facility

(76) Inventor: James L. Noel, Monroe, VA (US)

(21) Appl. No.: 13/366,909

(22) Filed: Feb. 6, 2012

Related U.S. Application Data
(60) Provisional application No. 61/512,644, filed on Jul. 28, 2011.
(60) Provisional application No. 61/440,545, filed on Feb. 8, 2011.
(60) Provisional application No. 61/512,644, filed on Jul. 28, 2011.
(60) Provisional application No. 61/440,545, filed on Feb. 8, 2011.

(51) Int. Cl. G21C 9/00; G21D 5/04

(52) U.S. Cl. 376/277; 60/644.1

(57) ABSTRACT

A nuclear island includes at least one nuclear reactor. A turbine island includes at least a turbine building housing at least one turbine driven by steam generated by the nuclear reactor. A protected area has a perimeter protected by at least one fence. An isolation zone surrounds the protected area and includes intrusion detection devices configured to detect unauthorized approach toward the protected area. The nuclear island is disposed inside the protected area, and the turbine island is disposed outside of and spaced apart from the protected area.

This application claims the benefit of U.S. Provisional Application No. 61/512,644 filed Jul. 28, 2011. This application also claims the benefit of U.S. Provisional Application No. 61/440,545 filed Feb. 8, 2011. U.S. Provisional Application No. 61/512,644 filed Jul. 28, 2011 is incorporated herein by reference in its entirety. U.S. Provisional Application No. 61/440,545 filed Feb. 8, 2011 is incorporated herein by reference in its entirety.

### BACKGROUND

The following relates to the nuclear power generation arts, nuclear power facility arts, nuclear reactor facility layout arts, and related arts.

Constructing a nuclear power facility is an extensive undertaking Initial concept through plant design and construction to generation of electrical power output can take in excess of a decade or longer and can cost hundreds of millions of dollars or more.

A nuclear power facility is designed to be a secure site. An emergency core cooling system (ECCS) is designed in conjunction with the nuclear reactor to safely shut down the nuclear reactor in the event of a loss of coolant accident (LOCA), loss of heat sink accident, or other event potentially impacting safety. Additionally, a nuclear power facility can be an attractive target for terrorists, violent activist groups, or the like. Accordingly most countries take steps to secure nuclear power facilities against external attack.

In the United States, regulations promulgated by the Nuclear Regulatory Commission (NRC) specify rules for securing a nuclear power facility against external attack. See, e.g. 10 C.F.R. Part 73 (available at http://www.nrc.gov/reading-rm/doc-collections/cfr/part073/, last accessed Jan. 28, 2011). In accordance with NRC regulations, a protected area is defined, whose perimeter is protected by physical barriers limiting access into the protected area. 10 C.F.R. §73.55(e)(8). Vital areas including at least the reactor control room, the spent fuel pool, and certain critical alarm components are located within the protected area. 10 C.F.R. §73.55(e)(9). An isolation zone is maintained in outdoor areas adjacent to a protected area perimeter barrier. 10 C.F.R. §73.55(e)(7). The isolation zone is sized and designed to permit unobstructed observation and assessment of activities on either side of the protected area barrier, and is monitored with suitable intrusion detection equipment capable of detecting and recording attempted or actual penetration of the protected area perimeter barrier before completed penetration of the protected area perimeter barrier. Id.

While NRC regulations specify certain aspects of nuclear facility security, it is recognized that each facility presents unique geographical, terrain, facility size, and other considerations. Accordingly, a site-specific security plan is developed for each nuclear power facility. See generally C.F.R. Title 10 Part 73.

Jurisdictions outside of the United States typically have an analog regulatory agency to the NRC which promulgates regulations for securing nuclear power facilities.

### BRIEF SUMMARY

In accordance with certain aspects disclosed herein, an apparatus comprises: a nuclear island including at least one nuclear reactor; a turbine island including at least a turbine building housing at least one turbine driven by steam generated by the nuclear reactor; a protected area having a perimeter protected by at least one fence; and an isolation zone surrounding the protected area and including intrusion detection devices configured to detect unauthorized approach toward the protected area. The nuclear island is disposed inside the protected area, and the turbine island is disposed outside of and spaced apart from the protected area.

In accordance with certain aspects disclosed herein, an apparatus comprises: a nuclear island including at least a nuclear reactor; a turbine building housing at least one turbine driven by steam generated by the nuclear reactor; a protected area having a perimeter protected by at least one fence; and an isolation zone surrounding the protected area and including intrusion detection devices configured to detect unauthorized approach toward the protected area. The isolation zone includes an engagement space surrounding the protected area and has a physical barrier field at least 30 feet wide and a sensor array surrounding the engagement space and configured to detect unauthorized approach toward the engagement space.

In accordance with certain aspects disclosed herein, an apparatus comprises a nuclear island including at least a nuclear reactor, and a turbine island including at least one turbine driven by steam generated by the nuclear reactor. The nuclear island and the turbine island are spaced apart from each other. The spacing between the nuclear island and the turbine island is 50 feet in some embodiments, and more preferably 100 feet, and still more preferably 130 feet. In some embodiments the nuclear island is maintained at a higher security level than the turbine island.

In accordance with certain aspects disclosed herein, an apparatus comprises: at least one nuclear reactor; at least one turbine driven by steam generated by the nuclear reactor; and an ultimate heat sink disposed underground and in operative communication with the nuclear reactor.

### BRIEF DESCRIPTION OF THE DRAWINGS

FIG. 1 diagrammatically shows an overhead (i.e., plan) view of a “2-pack” nuclear power facility including a nuclear island with two nuclear reactors.

FIG. 2 diagrammatically shows an overhead (i.e., plan) view of a “4-pack” nuclear power facility including a nuclear island with four nuclear reactors.

FIG. 3 diagrammatically shows an overhead (i.e., plan) view of a nuclear power facility in which the condensers are located outside the perimeter fence.

### DETAILED DESCRIPTION OF PREFERRED EMBODIMENTS

A nuclear power facility is typically designed for a particular electrical power output, which sets the size and other characteristics of the nuclear reactor and associated radiation containment and emergency core cooling system (ECCS), the electrical power-generating turbine or turbines, and so forth. The reactor is located in a containment building, critical ECCS components and rector support systems (i.e., spent fuels, rad waste) are located inside or closely proximate to the containment building thus forming a “nuclear island”. Remaining components (i.e., the “balance of plant”) including turbines, condensers, the electrical power distribution grid (i.e., the “switchyard”), are located near the nuclear island. Turbines for generating electrical power are driven by steam generated by the nuclear island, and are housed in a turbine building in close proximity to the nuclear island. This minimizes the lengths of steam lines running to the turbine building and feedwater lines running to the nuclear island, thus minimizing transient heat loss, piping considerations, and parasitic power loss (i.e., pumps) within this linkage, and enables the nuclear island and turbine building to constitute a single contiguous protected area for security purposes. The facility site is selected based on various considerations such as geographic proximity to power customers, foundational building support, seismic stability, availability of water for cooling, and so forth.

Facility design also incorporates security, especially for “vital equipment”, which is defined by the Nuclear Regulatory Commission (NRC) as “any equipment, system, device, or material, the failure, destruction, or release of which could directly or indirectly endanger the public health and safety by exposure to radiation. Equipment or systems which would be required to function to protect public health and safety following such failure, destruction, or release are also considered to be vital.” 10 C.F.R. §73.2. All vital equipment must be located in vital areas which in turn must be located in a protected area. 10 C.F.R. §73.55(e)(9). The protected area is a limited access area that is routinely patrolled by security personnel and is protected by physical barriers. See 10 C.F.R. §73.55(e)(8). The protected area is in turn surrounded by an isolation zone in outdoor areas that is sized to enable unimpeded observation of activities in both the isolation zone and the protected area, and is monitored with automated (and recording) intrusion detection sensors and alarms. Jurisdictions outside the United States are typically governed by similar security regulations or guidelines.

Conventionally, the nuclear power facility is constructed with a compact layout, with the turbine building and closely proximate nuclear island forming the core of a contiguous protected area. In some facility layouts, other portions of the balance of plant such as the switchyard and/or condensers are also included within the protected area. To accommodate elevated structures such as roof-mounted chillers for the turbine building, guard towers are established at suitable locations near the protected area perimeter to ensure that security personnel have continuous, unimpeded, and overlapping view of the entire protected area perimeter.

As disclosed herein, the conventional approach toward nuclear power facility layout has certain disadvantages, which are overcome by improvements disclosed herein.

In existing layouts for nuclear power facilities, operation and maintenance costs are high. For example, security costs are estimated to be approximately $25-30 million per year. This cost can be problematic for smaller nuclear power facilities, such as proposed small modular reactor (SMR) designs that produce no more than 300 megawatts (electrical). Moreover, the use of guard towers can be problematic since personnel posted in the guard towers are sedentary, which is not conducive to continual alertness that is desired of security personnel. In view of this, stationary guard postings ideally should have a personnel rotation every two hours or so. As stationary locations, guard towers near the perimeter are also known and well-defined targets for any external attack.

Existing nuclear plant facility layouts also complicate construction, maintenance, repair, and upgrade operations. Any work performed on the nuclear island, or in the turbine building, or anywhere else within the protected area must be performed by personnel who are cleared to work in the protected area. Where work is performed by contractors or other “outside” personnel, these personnel must be escorted while inside the protected area. Moreover, major upgrades within the protected area, such as adding a new turbine to a turbine island within the protected area of an existing facility, may require review and approval by one or more governing regulatory agency.

Still further, while existing nuclear power facilities are compact, they place substantial operational components within the protected area. This leads to a relatively large number of personnel present inside the compact protected area, which can be problematic in terms of security, personnel evacuation procedures, and so forth.

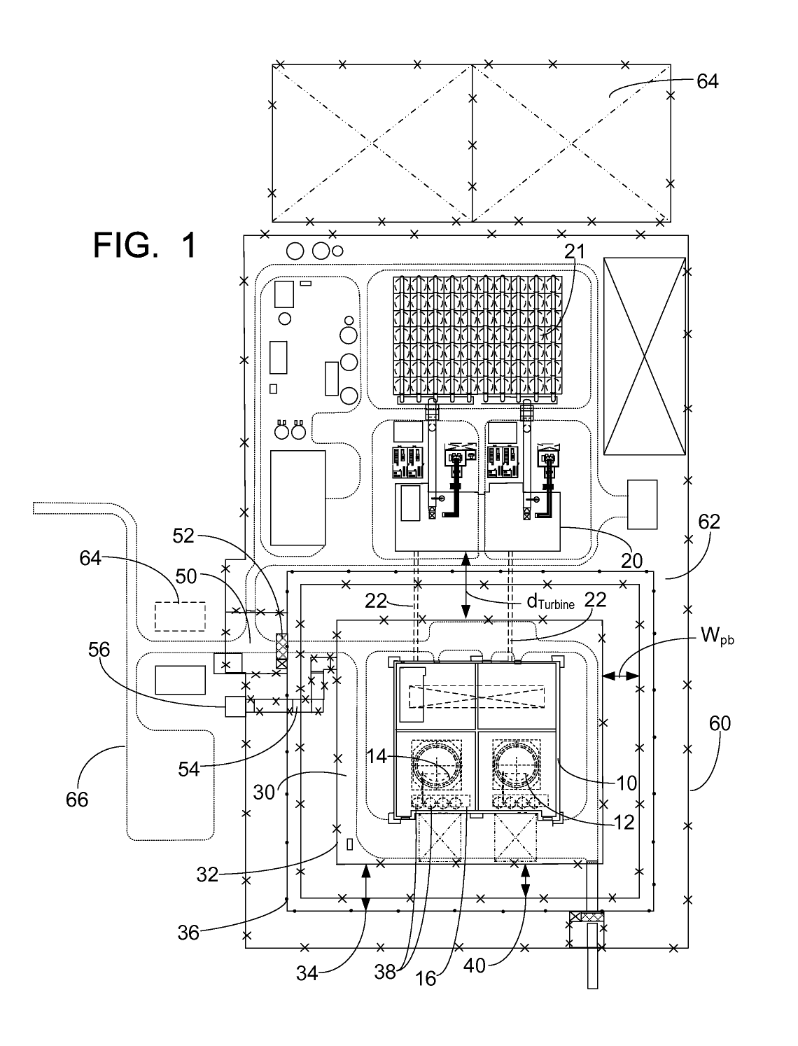

With reference to FIG. 1, an improved nuclear power facility disclosed herein is shown in plan view (that is, diagrammatic overhead view). The nuclear power facility includes a nuclear island comprising a containment building 10 containing at least one nuclear reactor (illustrative FIG. 1 shows a “two pack” containing two nuclear reactors 12, 14, and also shows a spent fuel pool 16 inside the containment building 10 for storing spent fuel after its removal from the reactor), and a turbine island including at least a turbine building 20 housing at least one turbine. The nuclear reactor or reactors 12, 14 may comprise substantially any type of nuclear reactor utilizing a primary circuit and a steam circuit, and in preferred embodiments comprises a pressurized water reactor (PWR). The nuclear reactor or reactors may be operatively connected with an external steam generator (not shown, but in such embodiments also housed within the containment building) via a primary coolant loop. In the illustrative example, the nuclear reactors 12, 14 are “integral” nuclear reactors in which the steam generators are located inside the reactor vessels. Some examples of this latter configuration are set forth in Thome et al., “Integral Helical Coil Pressurized Water Nuclear Reactor”, U.S. Pub. No. 2010/0316181 A1 published Dec. 16, 2010 which is incorporated herein by reference in its entirety, and at http://www.babcock.com/products/modular_nuclear/ (last accessed Jan. 29, 2011) (describing the B&W mPower™ integral small modular reactor design which is under development). U.S. Pub. No. 2010/0316181 A1 discloses an integral PWR employing a steam generator with helical coils; however, more generally the integral steam generator may employ straight tubes, e.g. a vertical tube once-through steam generator (OTSG) or another tubing configuration, and the secondary coolant may flow either inside the tubes (tube-side) with the primary coolant flowing around the tubes, or the secondary coolant may flow in a shell surrounding the tubes (shell-side) with the primary coolant flowing through the tubes. Whether an integral steam generator or a separate steam generator is employed, the purpose of the steam generator is to bring primary coolant (typically light water, although another type of primary coolant such as heavy water is also contemplated) flowing in the reactor into thermal communication with secondary coolant water (i.e., “feedwater”) that is thereby heated and converted to steam. Although there is thermal communication between the primary and secondary coolant within the steam generator, the primary and secondary coolant remain in fluid separation, that is, there is no intermixing between the primary and secondary coolant.

The secondary coolant steam flows via a steam line from the nuclear island to the turbine island to drive a turbine (or, turbine/electrical generator assembly) to generate electricity that is distributed to customers or other end users by the switchyard. In some embodiments the secondary coolant water flows in a closed loop path wherein the steam is condensed back into liquid water (i.e., liquid secondary coolant water) at the turbine island or condensers 21 and flows back to the nuclear island via a feedwater line. The steam line and optional feedwater line passes between the nuclear island and the turbine island via utility trenches 22.

It is to be understood that although diagrammatic FIG. 1 shows two nuclear reactors (i.e., a “2-pack”), more generally the nuclear island may include one nuclear reactor, two nuclear reactors, three nuclear reactors, four nuclear reactors, five nuclear reactor, six nuclear reactors, or so forth. When multiple reactors are included, it is contemplated for the nuclear island to be divided into two or more non-contiguous protected areas, or alternatively for the multiple reactors to be disposed within a single contiguous protected area (as in illustrative FIG. 1). Moreover, it is to be understood that diagrammatic FIG. 1 shows only selected salient features, while omitting numerous features known in the art.

With continuing reference to FIG. 1, a protected area 30 has a perimeter protected by at least one fence 32. An isolation zone 34 surrounds the protected area 30 and includes intrusion detection devices 36 (diagrammatically indicated in FIG. 1 by a dashed line surrounding the protected area 30; also suitably referred to as a “PIDAS” perimeter where the acronym “PIDAS” stands for “Perimeter Intrusion Detection and Assessment System”), such as thermal imaging cameras, vibration sensors, microwave detectors, motion detection cameras, various combinations thereof, or so forth configured to detect unauthorized approach toward the protected area 30. In embodiments intended for use in the United States, the type and density of sensors, types and number of physical barriers employed in the isolation zone, alarms in the protected area, and so forth suitably comply with NRC regulations for the isolation zone and protected area, for example as set forth in 10 C.F.R. §73.55.

As seen in FIG. 1, the nuclear island is disposed inside the protected area 30. (If multiple reactors are disposed at multiple contiguous and/or non-contiguous nuclear islands, the protected area encompasses all these contiguous and/or non-contiguous nuclear islands—in the illustrative example the two nuclear reactors 12, 14 are disposed in the single contiguous protected area 30). However, the turbine island is disposed outside of, and spaced apart from, the protected area 30. This arrangement takes advantage of the recognition made herein that (1) the turbine and related components are not vital equipment that must be in the protected area, and (2) the turbine and related components can be positioned relatively far away from the nuclear island.

Regarding item (1), the turbine island is not a vital area because the failure, destruction, or other compromising of the turbine island could not directly or indirectly lead to a release of radiation, and the turbine island is not required to function to protect public health and safety during any cognizable emergency event. Cf 10 C.F.R. §73.2. The turbine is driven by steam generated by the nuclear island; however, the steam driving the turbine is secondary coolant that is not contaminated with any radioactive material. A break in (or other failure or shutdown of) the steam line running from the nuclear island to the turbine island, or a break in (or other failure or shutdown of) the feedwater line running from the turbine island to the nuclear island, would not cause (either directly or indirectly) a release of radioactive material. At most, such a break or failure or shutdown could constitute a loss of heat sink event in which heat sink of the nuclear reactor by flow of secondary coolant in the steam generator might be compromised. The emergency core cooling system (ECCS) disposed with the reactor inside the containment building accommodates any loss of heat sink event by immediately shutting down the reactor, depressurizing any transient pressure rise caused by the loss of heat sink, and initiating cooling of the reactor core. The ECCS performs this shutdown using shutdown control rods, soluble poison injection, steam condensers located within the containment building, cooling water stored in a refueling water storage tank (RWST) located within the containment building, or other suitable apparatus, without releasing any primary coolant into the containment building ambient (much less into the external environment).

Regarding item (2), it is recognized herein that the turbine and related components can be positioned relatively far away from the nuclear island. This arrangement takes advantage of the ability to begin construction on the balance of the plant (i.e., structures outside of the nuclear island) in the pre-licensing stage, and supports parallel construction of the nuclear island with the balance of plant thereafter, thereby enabling realization of otherwise unobtainable construction benefits.

Conventionally, the turbine is located in close proximity to the nuclear island in order to minimize the length of the steam line running from the nuclear island to the turbine building. The rationale for this is that the steam line carries steam heated by the nuclear reactor via the steam generator, and so a longer steam line leads to more heat loss and lowered efficiency. However, comparison with other types of facilities, such as fossil fuel facilities, indicates that this concern is misplaced and that a steam line of order 100 feet or longer is feasible without problematic loss of heat.

In some embodiments the steam line and the feedwater line are at or below ground level, e.g. in the illustrative utility trenches 22 in FIG. 1. This can be advantageous in terms of enabling a greater amount of thermal insulation so as to further reduce any heat loss in the steam pipe. Burying these lines also provides improved security against external attack targeting these lines. Additionally or alternatively, in some embodiments the nuclear island is at least partially subterranean. In some embodiments the nuclear island is below ground and the protected area 30 has a maximum elevation of less than 20 feet. In some embodiments the nuclear island is below ground and the protected area 30 has a maximum elevation of less than 36 feet

While a facility at lower elevation (e.g., partially or wholly subterranean) is generally considered to be vulnerable to attack from a higher elevation, it is recognized herein that a partially or wholly subterranean facility has certain advantages from a security standpoint. By partially or wholly burying the nuclear island and placing the turbine outside of the protected area, the maximum elevation of the protected area can be made low, e.g. less than 20 feet in some embodiments, and less than 10 feet in some embodiments. This reduces the potential of having any obstructed view in the protected area. Indeed, in some embodiments it is contemplated to have no guard towers, since they are not needed to provide an unobstructed view over the entire protected area. The subterranean arrangement also can provide enhanced protection against aerial or projectile attack.

In some embodiments the ultimate heat sink (UHS) is both subterranean and also located inside the protected area within or closely proximate to the nuclear island. For example, in illustrative FIG. 1 a plurality of UHS pools 38 are located in the protected area 30. This arrangement further reduces the possibility that an external attack could sever pipes connecting the ECCS with the ultimate heat sink so as to compromise ECCS operation.

Indeed, as disclosed herein, the security plan for the nuclear power facility of FIG. 1 is substantially different from that conventionally employed at nuclear power facilities. The objectives are: (1) minimize the size of the protected area (even at the expense of a larger overall nuclear power facility); (2) minimize elevation within the protected area; (3) maximize delay elements; and (4) maximize operational efficiency.

Item (3) is accomplished in the illustrative example of FIG. 1 by creating an engagement space 40 surrounding the protected area 30 and having a physical barrier field at least 30 feet wide, and deploying the sensor array 36 surrounding the engagement space 40 and configured to detect unauthorized approach toward the engagement space 40. The physical barrier field suitably comprises a field of barbed wire, barbed tape, or razor wire, and has a width (denoted W_{pb} in FIG. 1) that is sufficient to substantially delay the time between detection of an intrusion via the surrounding sensor array and penetration of such intrusion to the perimeter (e.g., fence 32) of the protected area 30. Toward this end, while the physical barrier field is at least 30 feet wide, it is more preferably at least 80 feet wide, and still more preferably at least 100 feet wide. In conjunction with this, the spacing between the turbine island and the protected area 30 (denoted “d_{turbine}” in FIG. 1) is preferably at least 50 feet, and more preferably by at least 100 feet, and still more preferably at least 130 feet. The combination of a low elevation protected area and the wide physical barrier field ensures that any attacker is exposed over an extended period of time after detection before any possibility of the attacker entering the protected area. This delay paradigm is also incorporated into designed entryways to the protected area 30. For example, with reference to FIG. 1 a road 50 leading into the protected area 30 is (in addition to being monitored by security forces who also implement suitable vehicle search protocols) blocked by a movable physical barrier field portion 52 mounted on a sled or the like so that it can be moved off the road to allow an authorized vehicle to pass after it has been searched and cleared for entry. Similarly, a security personnel entry path 54 running from a security building 56 to the protected area 30 includes an extended dogleg equipped with deployable delay barriers, so that any intruder who gains access to the security building 56 and attempts to enter the protected area 30 via the security personnel entry path 54 will be delayed within the engagement space 40 for an extended period of time. Toward this end, the security personnel entry path 54 is preferably above-ground and in unobstructed view of the protected area 30.

In this security paradigm, security personnel are disposed in the protected area 30 as mobile patrols and/or ensconced within the reactor building within a short distance from multiple ballistically-protected defensive positions. In some embodiments, there are no guard towers or other stationary guard postings. By employing mobile patrols, and multiple defensive positions, security personnel tend to stay alert as they are frequently moving. The low elevation of the protected area 30 ensures unobstructed view of the entire protected area 30 and isolation zone 34, and the wide physical barrier field of the engagement space 40 ensures that any attempted intrusion will be delayed for an extended period of time.

With continuing reference to FIG. 1, in some embodiments a further security perimeter 60 is defined outside of the isolation zone/protected area. This further security zone is referred to herein as a security controlled area 62, and it surrounds both the isolation zone/protected area and other portions of the nuclear power facility such as the turbine island and the condensers 21. In the embodiment of FIG. 1 the security controlled area 62 does not include an electrical switch yard 64; however, in some embodiments the security controlled area surrounds the switch yard. The security controlled area 62 surrounds the nuclear island and the turbine island, and has lower security than the protected area 30. In illustrative FIG. 1, the security controlled area 62 comprises the alarmed perimeter fence 60 and a vehicle barrier system surrounding an outer perimeter 60 of the security controlled area 62, and a vehicle search station 64 at the entrance of each road entering the security controlled area 62. In some embodiments, the shortest distance from the outer perimeter 60 of the security controlled area 62 to the protected area 30 is greater than a blast radius determined by a blast analysis. In this case, the possibility that a detonation of a vehicle loaded with explosives could cause damage inside the protected area 30 is minimized if not eliminated. As a consequence, in some embodiments it is contemplated to locate the parking lot 66 for the nuclear reactor facility outside the security controlled area 62, without any vehicle search station at the entrance to the parking lot 66. Rather, only vehicles that enter the security controlled area 62 are searched (at the vehicle search station 64 in illustrative FIG. 1).

The disclosed nuclear power facility layout advantageously provides increased security for a given operational manpower level. For example, since vehicles entering the parking lot 66 do not need to be searched (as such vehicles remain outside of the blast radius as determined by a blast analysis), personnel who would otherwise be assigned to searching vehicles entering the parking lot can instead be allocated to other tasks relating to security, maintenance, plant inspection, or so forth. Placement of the turbine island outside of the protected area 30 similarly enables more efficient allocation of human resources in the vicinity of the turbine, and/or allows reallocation of some such personnel to the nuclear island.

Another advantage of the disclosed approach is that it facilitates modular construction of the nuclear power facility. Typically, construction cannot begin until final approval for the entire nuclear power facility has been granted by the NRC or other governing regulatory entity. With the improved layout disclosed herein, it may be possible to begin construction on the turbine island and other facilities located outside of the protected area 30 before final approval has been granted for the nuclear island.

The illustrative nuclear power facility of FIG. 1 is an illustrative “two-pack” design, in which the containment building 10 is constructed as two adjacent containment buildings in the illustrative single contiguous protected area 30. Each containment building contains one of the two small modular reactor (SMR) units 12, 14, with each SMR unit outputting no more than 300 megawatts (electrical). In some embodiments the two SMR units 12, 14 are two small modular pressurized water reactors (PWRs). The nuclear island of this embodiment is almost entirely subterranean, with only a slight protrusion above ground level. This, together with placement of the turbine island outside of the protected area 30, allows the protected area 30 to have a low elevational profile giving security personnel an unobstructed view over the entire protected area and adjacent surrounding isolation zone.

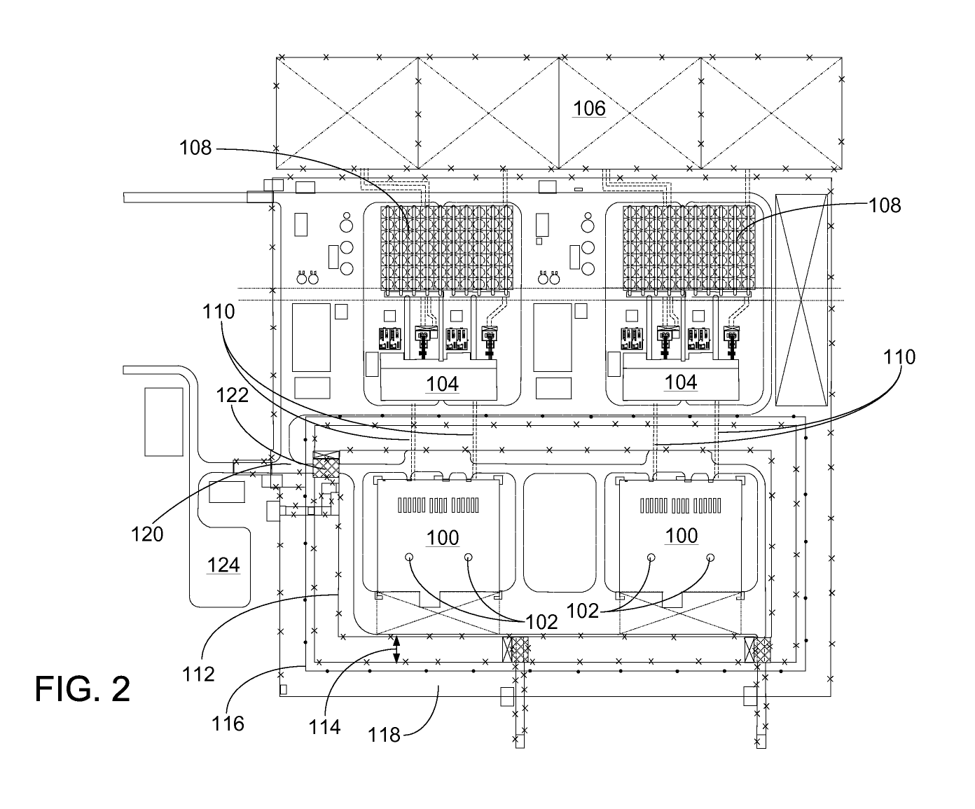

With reference to FIG. 2, a plan view of another illustrative nuclear power facility is shown. The nuclear power facility layout shown in FIG. 2 is a “4-pack” layout which includes four modular PWR reactors. The plan view of FIG. 2 shows two reactor service buildings 100 that include or (are disposed over subterranean) radiation waste facilities, fuel handling function/equipment, access control, control room, the reactor containment buildings, and ultimate heat sinks The locations of the four reactors, which are suitably SMRs, correspond approximately to four illustrated reactor building equipment hatches 102 providing access to the SMRs through the reactor service buildings 100. Other illustrated features include: two turbine buildings 104; the switchyard 106; air-cooled condensers 108; and tunnels 110 (e.g., for passing the feedwater and steam lines between the nuclear island and the turbine island). A protected area 112 is configured similarly to the protected area 30 of the two-pack design of FIG. 1. An engagement space 114 surrounding the protected area 112 is equivalent to the engagement space 40 of the embodiment of FIG. 1 and includes the physical barrier of barbed wire, barbed tape, or razor wire. An array of intrusion detection devices or PIDAS 116 surrounds the engagement space 114 and is equivalent to the PIDAS 36 of the embodiment of FIG. 1. A security controlled area 118 is equivalent to the security controlled area 62 of the embodiment of FIG. 1. A road 120 entering the protected area is controlled in the engagement space 114 by a motorized razor wire sled 122, providing access control equivalent to that provided by the movable physical barrier field portion 52. The parking lot 124 is again located outside the security controlled area 118.

The disclosed improved nuclear power facilities are suitably employed for substantially any type of nuclear power facility. The reduced operating and management costs associated with the disclosed improvements are especially useful in the context of small modular reactor facilities that generate no more than 300 megawatts (electrical).

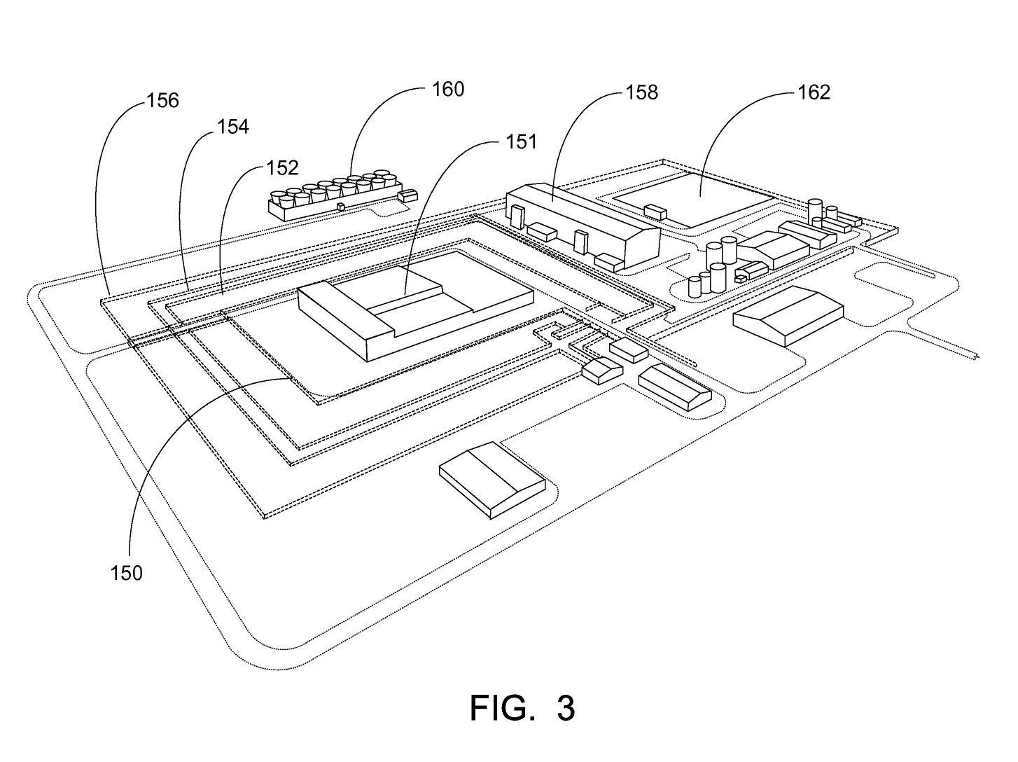

With reference to FIG. 3, an embodiment is shown which again includes a protected zone 150 containing the nuclear island 151 surrounded by an engagement space 152 monitored by a surrounding PIDAS 154, with an outermost security controlled area 156. As in previous embodiments, the turbine island 158 is located outside the protected zone 150 but inside the security controlled area 156. However, in the alternative embodiment of FIG. 3, the condensers 160 are located outside the perimeter fence (i.e., outside the security controlled area 156). The switchyard 162 is internal to the perimeter fence (i.e., inside the security controlled area 156), and additional buildings internal to the perimeter fence are deployed in alternative locations.

This application has described one or more preferred embodiments. Modifications and alterations may occur to others upon reading and understanding the preceding detailed description. It is intended that the application be construed as including all such modifications and alterations insofar as they come within the scope of the appended claims or the equivalents thereof.

1. An apparatus comprising:
a nuclear island including at least a nuclear reactor;
a turbine island including at least a turbine building housing at least one turbine driven by steam generated by the nuclear reactor;
a protected area having a perimeter protected by at least one fence; and
an isolation zone surrounding the protected area and including intrusion detection devices configured to detect unauthorized approach toward the protected area;
wherein the nuclear island is disposed inside the protected area; and
wherein the turbine island is disposed outside of and spaced apart from the protected area.

2. The apparatus of claim 1 wherein the turbine island is spaced apart from the protected area by at least 100 feet.

3. The apparatus of any one of claims 1-2 wherein the isolation zone comprises:
an engagement space surrounding the protected area and having a physical barrier field at least 30 feet wide; and
a sensor array surrounding the engagement space and configured to detect unauthorized approach toward the engagement space.

4. The apparatus of claim 3 wherein the engagement space has a physical barrier field that is at least 80 feet wide.

5. The apparatus of any one of claims 3-4 wherein the physical barrier field comprises a field of barbed wire, barbed tape, or razor wire.

6. The apparatus of any one of claims 1-5 further comprising:
a security controlled area surrounding the nuclear island and the turbine island, the security controlled area having lower security than the protected area.

7. The apparatus of claim 6 wherein the security controlled area comprises:
a fence surrounding an outer perimeter of the security controlled area; and
a vehicle barrier system comprising a vehicle search station at the entrance of each road entering the security controlled area.

8. The apparatus of any one of claims 6-7 further comprising:
a parking lot disposed outside the security controlled area, there being no vehicle search station at the entrance to the parking lot.

9. The apparatus of any one of claims 6-8 wherein the shortest distance from an outer perimeter of the security controlled area to the protected area is greater than a blast radius determined by a blast analysis.

10. The apparatus of any one of claims 1-9 wherein the apparatus does not include any guard towers.

11. The apparatus of any one of claims 1-10 wherein the nuclear island is at least partially subterranean.

12. The apparatus of any one of claims 1-10 wherein the nuclear island is below ground and the protected area has a maximum elevation of less than 36 feet.

13. The apparatus of any one of claims 1-12 wherein a steam line flowing steam from the nuclear island to the turbine island is disposed at or below ground level.

14. The apparatus of any one of claims 1-13 wherein the operational combination of the nuclear island and the turbine island is a small modular reactor (SMR) rated to generate no more than 300 megawatts of electrical power.

15. An apparatus comprising:
a nuclear island including at least a nuclear reactor;
a turbine building housing at least one turbine driven by steam generated by the nuclear reactor;
a protected area having a perimeter protected by at least one fence; and
an isolation zone surrounding the protected area and including intrusion detection devices configured to detect unauthorized approach toward the protected area, the isolation zone including an engagement space surrounding the protected area and having a physical barrier field at least 30 feet wide and a sensor array surrounding the engagement space and configured to detect unauthorized approach toward the engagement space.

16. The apparatus of claim 15 wherein the engagement space has a physical barrier field that is at least 100 feet wide.

17. The apparatus of any one of claims 15-16 wherein the apparatus does not include any guard towers.

18. The apparatus of any one of claims 15-17 wherein the nuclear island is below ground and the protected area has a maximum elevation of less than 36 feet.

19. An apparatus comprising:
a nuclear island including at least a nuclear reactor;
a turbine island including at least one turbine driven by steam generated by the nuclear reactor;
wherein the nuclear island and the turbine island are spaced apart from each other.

20. The apparatus of claim 19, wherein at least two layers of security separate the nuclear island and the turbine island.

21. The apparatus of any one of claims 19-20, wherein the nuclear island is maintained at a higher security level than the turbine island.

22. The apparatus of any one of claims 19-21, wherein the nuclear island and the turbine island are spaced apart by at least 50 feet.

23. The apparatus of any one of claims 19-21, wherein the nuclear island and the turbine island are spaced apart by at least 100 feet.

24. The apparatus of any one of claims 19-21, wherein the nuclear island and the turbine island are spaced apart by at least 130 feet.

25. The apparatus of any one of claims 19-24, wherein the nuclear island is at a relatively lower elevation than the turbine island.

26. The apparatus of any one of claims 19-24, wherein the nuclear island is subterranean and the turbine island is mostly or completely above-ground.

27. The apparatus of any one of claims 19-26, further comprising a subterranean ultimate heat sink in operative communication with the nuclear island.

28. The apparatus of any one of claims 19-27, wherein the nuclear island is in a protected area as defined by 10 C.F.R. Part 73 as constituted Feb. 2, 2011 and the turbine island is not in a protected area as defined by 10 C.F.R. Part 73 as constituted Feb. 2, 2011.

29. The apparatus of any one of claims 19-27, wherein the nuclear island is in a protected area and the turbine island is not in a protected area.

30. An apparatus comprising:
at least a nuclear reactor;
at least one turbine driven by steam generated by the nuclear reactor; and
an ultimate heat sink disposed underground and in operative communication with the nuclear reactor.
